(19) United States
(12) Patent Application Publication
(10) Pub. No.: US 2024/0265033 A1
(43) Pub. Date: Aug. 8, 2024

(54) ELASTIC CONNECTION POOLS FOR DATABASE NODES

(71) Applicant: Salesforce, Inc., San Francisco, CA (US)

(72) Inventors: Olumayokun Obembe, Concord, CA (US); Sidarth Conjeevaram, San Jose, CA (US); Jason Woods, Toronto (CA); Jia-Yu Chen, San Francisco, CA (US); Vijayanth Devadhar, Fremont, CA (US)

(21) Appl. No.: 18/440,195

(22) Filed: Feb. 13, 2024

Related U.S. Application Data
(63) Continuation of application No. 17/098,669, filed on Nov. 16, 2020.

(51) Int. Cl. G06F 16/27

(52) U.S. Cl. CPC G06F 16/278

(57) ABSTRACT

Elastic connection pools for database nodes are described. A system receives a user request that references data in a database, and uses the user request to identify a partition of multiple partitions of the database. The system uses the identified partition to identify a database node in a cluster of database nodes. The system uses the identified database node to identify a connection pool of multiple connection pools provided by an application server. If the identified connection pool does not have any available connections to the identified database node, the system uses connection criteria to select another connection pool of the remainder of the connection pools. The system enables the user request to access the referenced data in the identified partition of the database by providing the user request with an available connection, from the other connection pool, to another database node in the cluster.

### RELATED APPLICATIONS

The present application is a continuation of U.S. application Ser. No. 17/098,669, entitled “ELASTIC CONNECTION POOLS FOR DATABASE NODES,” filed Nov. 16, 2020, the disclosure of which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A distributed database management system enables users to access a single database instance that is divided across a network of servers, which may be referred to as a cluster of database nodes, to maximize availability. If a database node becomes unavailable, a distributed database management system can failover a user's session that was connected to the now unavailable database node to another database node, while hiding the impact of the unavailable database node from the user.

A cluster of database nodes can maintain affinity between each database node and its data blocks. For example, if the database node 1 requests to access a data block that is owned by, or mastered on, the database node 2, then the cluster of these database nodes can transfer that data block from the database node 2 to the database node 1. If the cluster of these database nodes detects that the database node 1 is accessing the data block that is owned by the database node 2 more frequently than the database node 2 accesses the data block, the cluster can transfer the ownership of the data block from the database node 2 to the database node 1. This ownership transfer of the data block can result in a cluster wait event, or a “remastering freeze,” as the cluster notifies all database nodes in the cluster about this ownership change of the data block.

A distributed database management system may divide a database into partitions, and map the database partitions to database nodes, which cache their corresponding database partitions. Subsequently, after receiving a user's request that refers to data, the distributed database management system can use a hash function and an identifier of the referenced data to hash the user's request to the data partition for the referenced data and then enable the user request to access the data partition's data block for the referenced data via the database node mapped to that database partition. Accessing the referenced data by connecting the user's request to the database node that is mapped to and caches the database partition which stores the data block for the referenced data efficiently leverages the database node's cache and reduces communication and data traffic between the cluster of database nodes. A consequence of this mapping from database partitions to database nodes is that if a cluster of database nodes cannot acquire a connection to the database node that is mapped to the database partition that stores the data block for the referenced data, the user's request may not be executed.

A cluster of database nodes can provide a connection from a database instance's connection pools, defined as the set of all connection pools across all application servers, for a user's request to access data, unless every connection is in use and creating a new connection is not currently possible. When a distributed database management system receives a user's request that refers to data, a networked load balancer can assign the user's request to one of multiple application servers. Then the assigned application server can use a hash function and an identifier of the referenced data to hash the user's request to the database partition that stores the data block for the referenced data, maps the database partition to the specific database node that caches the database partition, and checks if the connection pool for that specific database node has any available connections to that specific database node. If the connection pool for that specific database node does not have any available connections to that specific database node, the assigned application server can forward the user's request to a different application server, which may have available connections to that specific database node.

However, a connection pool that provides connections to a database node may become overwhelmed by user requests. For example, if the application server 1 has the connection pool 1 which includes 20 available connections for the database node 1, and the connection pool 1 simultaneously receives more than 30 user requests that refer ro data owned by the database node 1, then several of these user requests may fail. A single connection pool cannot successfully serve a burst of user requests that arrive at a single application server and attempt to use the single connection pool. As a consequence of any of the user requests failing, the corresponding top-level web request may fail entirely, and a “server unavailable” error message may be displayed to the user, thereby creating a negative experience for the user.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates an example system for elastic connection pools for database nodes, in an embodiment;

FIG. 2 illustrates an example routing layer for elastic connection pools for database nodes, in an embodiment;

FIG. 3 is an operational flow diagram illustrating a high-level overview of a method for elastic connection pools for database nodes, in an embodiment;

FIG. 4 illustrates a block diagram of an example of an environment wherein an on-demand database service might be used; and

FIG. 5 illustrates a block diagram of an embodiment of elements of FIG. 4 and various possible interconnections between these elements.

### DETAILED DESCRIPTION

### General Overview

An application server's connection pools may fail to provide a connection to a database node even if some of the connection pools have available connections for their database nodes. For example, if the connection pool 1 for the application server 1 has 0 available connections for the database node 1, but the application server 1 has other connection pools 2 and 3 that have many available connections to the database nodes 2 and 3, a user's request that refers to data owned by the database node 1 may fail. The failure may be due to a call to the connection pool throwing an exception, such as a ConnectionPoolTimeOutException or ConnectionPoolTooManyWaitersException. Such exceptions may occur if a user request has waited for more than a threshold amount of wait time or if the number of waiting user requests is greater than a threshold number of waiters.

In accordance with embodiments described herein, there are provided systems and methods for elastic connection pools for database nodes. A system receives a user request that references data in a database and uses the user request to identify a partition of multiple partitions of the database. The system uses the identified partition to identify a database node in a cluster of database nodes. The system uses the identified database node to identify a connection pool of multiple connection pools provided by an application server. If the identified connection pool does not have any available connections to the identified database node, the system uses connection criteria to select another connection pool of the remainder of the connection pools. The system enables the user request to access the data in the identified partition of the database by providing the user request with an available connection, from the other connection pool, to another database node in the cluster.

For example, an Oracle distributed database management system receives a request from the computer sales manager Chris' laptop computer to retrieve October computer sales data from an Oracle Customer Relationship Management (CRM) database, and assigns the request to one of the Oracle application servers. The assigned application server uses a hash function to hash Chris' request to the hash value for the database partition 1, which stores the October computer sales data, in the Oracle CRM database. The application server uses a mapping function to map the hash value for the database partition 1 to the map value for the database node 1 in an Oracle Real Application Cluster (RAC) of database nodes 1-9. Since the Oracle RAC had 9 database nodes, the application server has 9 corresponding connection pools, including the connection pool 1 that provides connections to route user requests to the database node 1.

Since the connection pool 1 does not have any available connections for the database node 1, the application server uses connection criteria to select the application server's connection pool 9 for the Oracle RAC's spare database node 9. This specific selection is based on the connection pool 9 having more available connections than any of the application server's connection pools 1-8 and because the spare database node 9 has a lower CPU utilization than any of the Oracle RAC's database nodes 1-8. The application server uses an available connection from the connection pool 9 to route Chris' request to the spare database node 9, which uses the Oracle RAC's Interconnect network to request the data block that is in the database partition 1 and stores the October computer sales data. The database node 1, which caches the database partition 1 that includes the requested data block, responds to the Interconnect request by sending the requested data block via the Interconnect network to the spare database node 9. Then the spare database node 9 enables Chris to retrieve the October computer sales data that is stored in the database partition 1 of the Oracle CRM database, even though the application server's connection pool 1 has no available connections to the database node 1 that caches the database partition 1 which stores the October computer sales data.

While one or more implementations and techniques are described with reference to an embodiment in which elastic connection pools for database nodes is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

Systems and methods are provided for elastic connection pools for database nodes. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. Systems and methods for elastic connection pools for database nodes will be described with reference to example embodiments. The following detailed description will first briefly describe overviews of a system for elastic connection pools for database nodes.

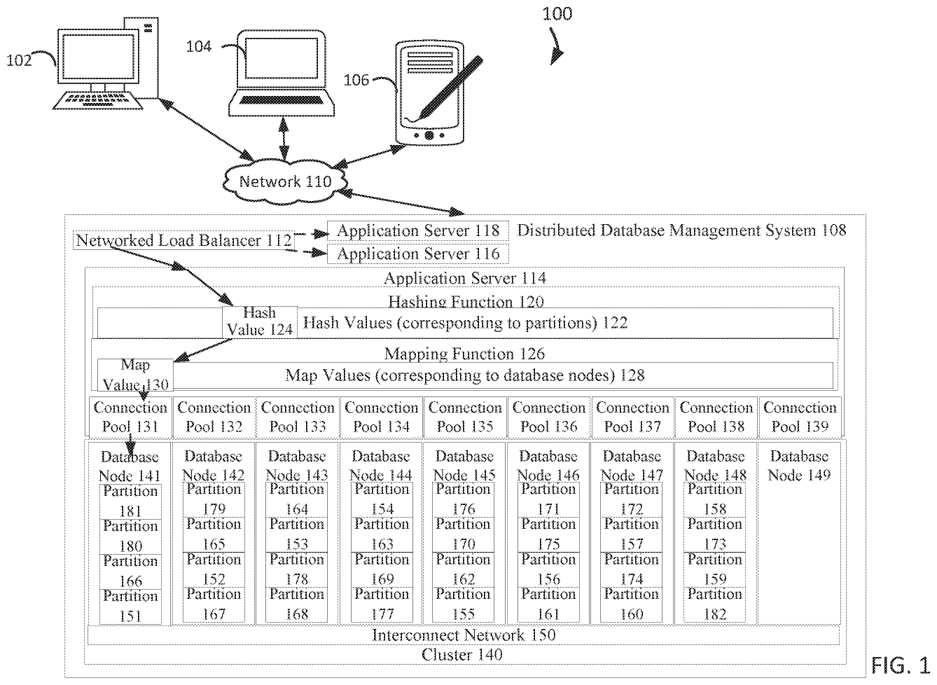

FIG. 1 depicts an example of a system for elastic connection pools for database nodes, in an embodiment. As shown in FIG. 1, a system 100 may illustrate a cloud computing environment in which data, applications, services, and other resources are stored and delivered through shared data centers and appear as a single point of access for the users. The system 100 may also represent any other type of distributed computer network environment in which servers control the storage and distribution of resources and services for different client users.

In an embodiment, the system 100 represents a cloud computing system that includes a first client 102, a second client 104, and a third client 106; and a distributed database management system 108, that may be provided by a hosting company.

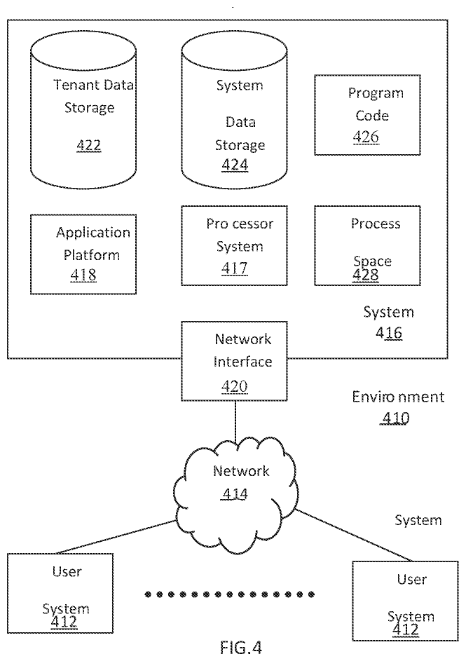

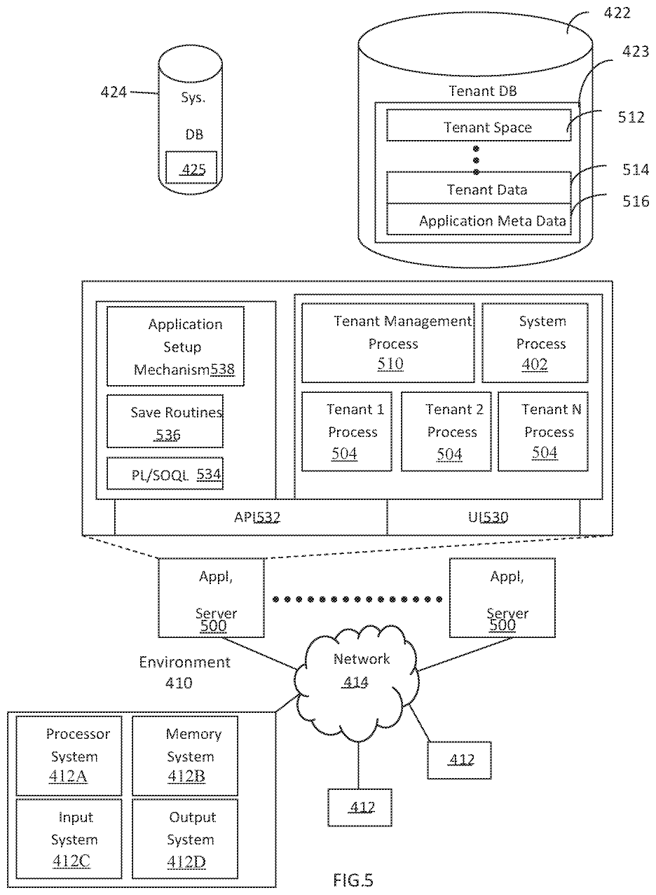

Although FIG. 1 depicts the first client 102 as a desktop computer 102, the second client 104 as a laptop computer 104, and the third client 106 as a mobile phone 106, each of the clients 102-106 may be any type of computer. The clients 102-106 and the distributed database management system 108 communicate via a network 110. Although FIG. 1 depicts the system 100 with three clients 102-106, one distributed database management system 108, and one network 110, the system 100 may include any number of clients 102-106, any number of distributed database management system 108, and any number of networks 110. The clients 102-106 and the distributed database management system 108 may be substantially similar to the systems depicted in FIGS. 4-5 and described below.

Although the distributed database management system 108 may be referred to as the Oracle distributed database management system 108, and examples describe elements of FIG. 1 as Oracle elements, embodiments of this disclosure can apply to other types of the distributed database management system 108. The Oracle distributed database management system 108 receives user requests that reference data in a database. For example, the Oracle distributed database management system 108 receives a request from the computer sales manager Chris' laptop computer 104 to retrieve October computer sales data from an Oracle CRM database. The Oracle distributed database management system 108 can include a networked load balancer 112 that distributes the user requests from the clients 102-106 to the application servers 114-118. For example, the Oracle distributed database management system 108 uses the networked load balancer 112 to assign Chris' request to the application server 114. An application server can be a computer that executes a computer program that performs a particular task or set of tasks.

Following assignment of user requests, the application server 114 applies a hashing function 120 to an identifier of the data referenced in each user request to generate hash values that correspond to database partitions 122, which correspond to the partitions 151-182 of the Oracle database, which may be mapped to the database nodes 141-149 in a non-sequential order. For example, the application server 118 uses the hashing function 120 to hash Chris' request to the hash value 124 for the database partition 151, which stores the October computer sales data, in the Oracle CRM database. A user request can be an instruction from a computer operator for a computer to manage information. Data can be information. A database can be structured information stored in a computer. A partition can be a subgroup of information that is stored as a sub-unit.

The Oracle distributed database management system 108 may divide a CRM database into multiple partitions, such as 32 partitions. An identifier of the organization of data in a database may be referred to as an org id, an organization id, an organization identifier, and/or an operating unit. The application servers 114-18 can use the organization identifier provided with a user request to identify any partition of the database that currently stores the data referenced by the user request or will store the data referenced by the user request.

Having hashed the user request to the hash values 122 (that correspond to database partitions 151-182), the application server 114 uses a mapping function 126 to map the hash values 122 to the map values 128 (which correspond to database nodes 141-149), which correspond to the Oracle cluster 140 of the database nodes 141-149. For example, the application server 114 uses the mapping function 126 to map the hash value 124 for the database partition 151 to the map value 130 for the database node 141.

The application server 114 identifies the connections pools 131-139 that correspond to the cluster 140 of the database nodes 141-149, which may be an Oracle RAC 140 in which the database nodes 141-149 use the Interconnect network 150 to communicate with each other and transfer data blocks with each other. The database nodes 141-149 cache the partitions 151-182 of an Oracle CRM database. For example, the application server 114 identifies the connection pool 131 that provides connections to route requests to the database node 141. Since the map values 128 corresponds to the database nodes 141-148, the application server 114 uses a connection pool service to check if the connection pools 131-138 corresponding to the database nodes 141-148 have any available connections to the corresponding database nodes 141-148. For example, the application server 114 determines whether the connection pool 131 has any available connections for the database node 141.

A connection pool can be a set of initialized computer communication links that are kept ready for use. An available connection can be an initialized computer communication link that is ready for use. A cluster can be a set of connected computers that work together. A database node can be a networked computer that manages access to structured information.

If the connection pools 131-138 have available connections to the corresponding database nodes 141-148, the application server 114 can provide each user request with an available connection, from the connection pools 131-138, to the corresponding database node of the database nodes 141-148, which enables the user request to access the data in the corresponding partition of the partitions 151-182 of the database. For example, the application server 114 uses an available connection from the connection pool 131 to connect Chris' request to the database node 141, because the application server 114's connection pool 131 has available connections to the database node 141 that caches the partition 151 that stores the October computer sales data. Continuing the example, the database node 141, which caches the database partition 151 that stores the data block for the referenced data, responds to Chris' request by sending the data block for the October computer sales data to Chris' laptop computer 104 to retrieve the October computer sales data that is stored in the partition 151 of the Oracle CRM database.

However, if the identified connection pool does not have any available connections to the corresponding database node, the application server 114 may use a connection from another connection pool for another database node, such as the connection pool 139 for the spare database node 149, to enable the user request to access the referenced data. In the cluster 140 of the database nodes 141-149, the spare database node 149 is the database node 149 that does not have any partitions mapped to it. Therefore, a spare database node can be a supplemental networked computer that manages access to structured information, and that is not associated with any partition of structured information.

With respect to capacity planning, the Oracle distributed database management system 108 does not assign any capacity to the spare database node 149. If the capacity projection for a database instance is 8 database nodes 141-148, then the cluster 140 has 8 active database nodes 141-148, and one spare database node 149. When any one of the active database nodes 141-148 becomes unavailable, the capacity of the cluster 140 decreases, and the cluster 140 uses the spare database node 149 to restore the previous capacity of the cluster 140, not to add new capacity to the cluster 140. If the cluster 140 of the database nodes 141-148 added the spare database node 149 as an additional database node 149, instead of as a temporary replacement database 149, then the cluster 140 could become accustomed to using 9 active database nodes 141-149. Then the cluster 140 of the database nodes 141-149 may have difficulty adjusting to using only 8 of the 9 database nodes 141-149, which the cluster 140 would be forced to if one of the database nodes 141-149 becomes unavailable. In such a situation, the Oracle distributed database management system 108 should have provisioned the database instance with 9 active database nodes 141-149 and a tenth database node (which is not depicted in FIG. 1) to serve as the new spare database node.

In situations when a temporary increase in user requests overwhelms any of the connection pools 131-138, the application server 114 can use the connection pool service to effectively convert the overwhelmed connection pool into an elastic connection pool by distributing the user request across the other connection pools 131-139 provided by the assigned application server 114 for connecting to the other database nodes 141-149. However, using a connection from the other connection pools 131-139 provided by the assigned application server 114 to connect to other database nodes 141-149, which are not mapped to the identified database partition, can create consequences for the Oracle distributed database management system 108. These consequences can include creating risks associated with producing data and communication traffic between the database nodes 141-149, propagating faults, impacting capacity planning, violating a contract with a message's consumer, and negatively impacting other users.

The cluster 140 of the database nodes 141-149 already has the capability to use the “incorrect” database node 149 to access the identified database partition. For example, if the database node 142 requests to access a data block that is owned by the database node 141, then the cluster 140 of the database nodes 141-149 transfers that data block from the database node 141 to the database node 142 through the Interconnect network 150. Consequently, using the “incorrect” connection from the “incorrect” connection pool 139 to connect to the “incorrect” database node 149 to request the “correct” partition is an expansion of the existing capabilities of the cluster 140 of the database nodes 141-149.

The risks of propagating faults increase as any of the connection pools 131-139 becomes clastic. If any of the connection pools 131-138 is exhausted, because all connections have been checked out by a user request that fails to return its connections due to an application code error, allowing that user request to acquire additional connections from other connection pools 131-139 may result in an even more negative experience for the user. Risks also exist if a user request executes faulty Apex code, drives row-lock contention, acquires a connection before an external callout, or invokes parallelStream with a lambda that invokes DBContext.get( )getConnection( ). By embedding the mapping from the database partitions 151-182 to the database nodes 141-149 into the connection pools 131-139 provides natural fault isolation.

Relaxing compliance with the mapping from the database partitions 151-182 to the database nodes 141-149 in the connection pools 131-139 may impact capacity projections. For example, if hashing an organization identifier of data to any of the partitions 151-182 results in a sustained need to overflow into another connection pool 131-139, that organization identifier of data may need to be transformed into an organization identifier of data for multiple database nodes. A sustained need to periodically overflow may indicate that an integration or feature's implementation needs to be reviewed and possibly revised. Therefore, the Oracle distributed database management system 108 can record detailed information about every situation in which a connection pool overflow occurs.

A message queue's concurrency control Application Programming Interface (API) allows a message queue consumer to specify that only a predetermined number of message types may be concurrently processed by the database node 141-149. For example, a message queue dequeues a message using a connection to the database node 141, and the consumer of the message has requested that only one message type be concurrently processed per the database nodes 141-149. If the message queue requests for a connection to database node 141, and the Oracle distributed database management system 108 automatically provides a connection to the database node 142 because the connection pool 131 for the database node 141 has 0 connections, then the message queue may unintentionally violate its contract with the message's consumer when another message of the same type is being processed on the database node 142. There may be other such functional problems that arise when a request for a connection to the database node 141 is answered with a connection to the other database node 142.

Some services, such as message queue, attempt to obey a database management system's many “traffic lights.” For example, if a message queue dequeues a message on the database node 141, and the message queue determines that the database node 141 has a high database CPU utilization, then the message consumer's contract requires that the message queue re-enqueue the message. However, the message queue may dequeue a message for the database node 142, ask for a connection to the database node 142, and respond to the lack of available connections to the database node 142 by re-enqueuing the message, identifying available connections in the connection pool 131 for the database node 141. and connecting to the database node 141. If the database CPU utilization in the database node 141 is high, then the message queue has unintentionally violated its contract with the message's consumer. Therefore, certain services need to avoid getting connections from specific connection pools 131-139.

Allowing a user request to overflow into any of the other connection pools 131-139 may impact the experience of users who are using and, according to the database partition-to-database node mapping, are supposed to be using the connection pool being overflowed into. If the Oracle distributed database management system 108 limits the situations when a connection pool 131-139 is made elastic, such risks may be reduced or eliminated.

Many options exist for implementing an elastic connection pool API, including implementations associated with getConnection, ConnectionPool2, and ConnectionAcquirer. Almost every connection is ultimately acquired from a connection pool by a call to ConnectionPool2#getConnection. An invocation of getConnection throws a ConnectionPoolTimeOutException if no connection is available and throws a ConnectionPoolTooManyWaitersException if the waitlist for the corresponding connection pool is full. User requests can reach that invocation of getConnection by establishing a DBContext or by directly interacting with a ConnectionPool2. Before throwing an exception, getConnection can call the elastic connection pool API and ask for a connection. The elastic connection pool API may hide every individual connection pool access, so that the elastic connection pool API would determine how to get a connection, even if such a requirement may require much refactoring. Even though only DBContext uses ConnectionAcquirer, ConnectionAcquirer can call the elastic connection pool API. The elastic connection pool API may be delegated to ConnectionPool2, and if the delegation results in throwing an exception on getConnection, the elastic connection pool API may be invoked. An example of Java code for calling the elastic pool connection service is provided below:

```
interface ElasticConnectionPoolService {
  ConnPoolsConnection getConnection(
    ConnectionPoolType poolType,
    GetConnParams getConnParams);
}
```

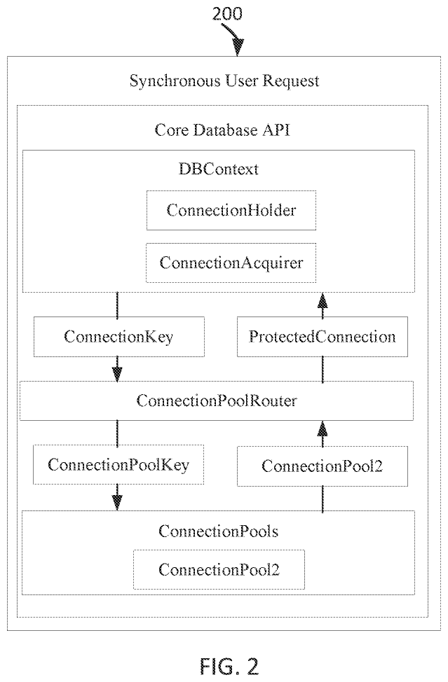

This example of Java code for calling the elastic pool connection service may be implemented by the Oracle distributed database management system 108 introducing a new routing layer, such as the example routing layer 200 depicted in FIG. 2:

The application servers 114-118 can identify whether a user request is a candidate for using an elastic connection pool, which may be based on whether or not the user request is a synchronous request. For example, as a salesperson is waiting in a customer's lobby to visit the customer, the salesperson's request for their Oracle CRM database to provide a critical update about that customer is processed as a synchronous request so that the salesperson receives the response to the request while waiting for the customer to arrive in the lobby. In another example, as an automated report generator requests the Oracle CRM database to produce a weekly report at midnight each Saturday, the requests may be processed as asynchronous requests because there may be no human waiting for the weekly report if no available connection currently exists to the database node that caches the partition that stores the data for the weekly report. A synchronous request can be an instruction from a computer operator for a computer to contemporaneously manage information.

A synchronous user request typically establishes a DBContext, and upon failing to acquire a connection, a synchronous user request establishes a RequestContext. Therefore, if a DBContext or a RequestContext a is established, the application servers 114-118 can determine that the user request is a synchronous user request and is also a candidate for using the elastic connection pool. Requiring that a RequestContext be established enables the application servers 114-118 to only overflow a connection pool when a synchronous customer request fails to acquire a connection. If an endpoint is known to be broken, or (comparatively) unimportant, the endpoint may be recorded in a disallow-list for using elastic connection pool.

The application servers 114-118 can execute code similar to the example Java code below to determine if a user request's connection request is a candidate for routing to a specified database node:

```
interface ConnectionKey {
  @Nullable
  String getOrgId( );
  @Nullable
  String getUserId( );
  @Nullable
  Integer getRandomSeed( );
}
```

A user request may be eligible for diversion to another database node if the organization-connection request requests a connection via the DBContext and is initiated by an apex compile task, a web Request, a search query, or a user interface instrumentation task.

After hashing a user request to one of the partitions 151-182, mapping the partition to one of the database nodes 141-149, and determining that the connection pool for the mapped database node does not have any available connections to that database node, the assigned application server can attempt to acquire a connection via a careful selection from the remainder of the connection pools 131-139. To select the connection pool that should be leveraged, the elastic connection pool API can internally maintain distinct connection strategies and characteristics, which may not be mutually exclusive, and which may be referred to as connection criteria. These connection criteria for selecting a connection pool may be based on a connection pool's total count of available connections, association with any database partition, association with a database partition that is being accessed more than a threshold amount, and/or a corresponding database node's central processor unit utilization. A connection criterion can be a strategy and/or a characteristic associated with a set of initialized computer communication links that are kept ready for use. A remainder can be a part of something that is left over when other parts have been removed from consideration.

Identifying each connection pool's total count of available connections enables an application server to select the connection pool with the most available connections. Identifying each connection pool's association with any database partition enables an application server to select the connection pool for the cluster's spare database node, which is not associated with any partition. Identifying each connection pool that is mapped to a database partition which is being accessed more than a threshold amount enables an application server to select a connection pool that is not mapped to a heavily accessed database partition. Identifying each database node's central processor unit utilization enables an application server to select the connection pool that is mapped to a database node with the lowest CPU utilization.

A total count can be an aggregation of the number of items. An association can be a relationship with an entity. A threshold amount can be the magnitude that must be satisfied for a certain reaction, phenomenon, result, or condition to occur or be manifested. A central processor unit utilization can be the usage of the primary component of a computer for executing instructions.

Selecting the connection pool 139 for a cluster's spare database node 149 may be a challenge from a capacity planning standpoint. The Oracle distributed database management system 108 typically uses the spare database node 149 to accommodate a temporary increase in the database capacity (such as database CPU cycles) required by a user to be successful. Since the spare database node 149 does not normally serve user traffic, the Oracle distributed database management system 108 can use the spare database node 149, rather than any other database node 141-148, to support one user without reducing the capacity available to another user. Similarly, the application servers 114-118 can opportunistically send traffic to the spare database node 149 to seamlessly manage transient bursts in connection requests.

For example, since the connection pool 131 does not have any available connections for the database node 141, the application server 114 uses connection criteria to select the application server's connection pool 139 for the Oracle RAC's spare database node 149. For this example, the specific selection may be based on the connection pool 139 having more available connections than any of the application server 114's connection pools 131-138 and because the spare database node 149 has a lower CPU utilization than any of the Oracle RAC 140's database nodes 141-148. In an alternative or supplemental example, the specific selection may be based on selecting whichever one of the connection pools 131-139 corresponds to whichever of the database nodes 141-149 has the status as the spare for the cluster 140, which is the connection pool 139 for the spare database node 149. In an alternative example, the specific selection may be based on selecting the connection pool 132, which is for the database node 142, because none of the partitions cached by the database node 142 is a database partition that is currently being heavily accessed.

To prevent users from overwhelming any of the connection pools 131-139, the application server 114 can use connection criteria to limit the percentage of any connection pool's connections that may be diverted by other connection pools 131-139 by restricting the selection of a connection pool when any other connection pool lacks available connections. For example, after 50% of the available connections in the connection pool 139 for the spare database node 149 have been diverted by the connection pools 131-138, the application server 114 denies any requests by the connection pools 131-138 to divert connection requests to the connection pool 139 until the percentage of the diverted connections from the connection pool 139 drops below 50% of the original number of available connections in the connection pool 139. A limit can be a restriction. A selection can be the action of carefully choosing something as being suitable.

Since some features such as database automation patching rely on the existence of the spare database node 149, the application server 114 can limit the utilization of the spare database node 149 based on a percentage of peak utilization time of the cluster 140, a percentage of total utilization time of the cluster 140, a total count of the database nodes 141-149 of the cluster 140, and/or a total count of the application servers 114-118. Identifying a total count of the database nodes of a cluster and/or a total count of the application servers enables an application server to limit the utilization of a spare database node based on a percentage of the database nodes of the cluster and/or a percentage of the application servers. A peak utilization time can be when an entity is used at its greatest capacity. A total utilization time can be a chronological aggregation of an entity's use.

For example, after the length of time that available connections in the connection pool 139 for the spare database node 149 have been diverted by the connection pools 131-138 has aggregated to a total of 4 hours during the 8 hours of peak usage of the cluster 140 from 9:00 A.M. to 5:00 P.M., the application server 114 denies any requests by the connection pools 131-138 to divert connection requests to the connection pool 139. In another example, the application server 114 denies any requests by the connection pools 131-138 to divert connection requests to the connection pool 139 after the length of time that available connections in the connection pool 139 for the spare database node 149 have been diverted by the connection pools 131-138 has aggregated to a total of 12 hours during any 24 hour period use of the cluster 140. In yet another example, the application server 114 denies any requests by the connection pools 131-138 to divert connection requests to the connection pool 139 after the connection pools 131-138 for more than 50% of the 9 database nodes 141-149 in the cluster 140 have diverted connection requests to the connection pool 139. In an additional example, the application server 114 denies any requests by the collection pools for the application server 118 to divert connection requests to the connection pool 139 after the connection pools 131-138 for the application server 116 have diverted connections requests to the connection pool 139, which prevents connection pools for 100%.of the application servers 114-118 from diverting connection requests to the connection pool 139. Although some examples describe various situations in which the application server 114 denies any requests by various collection pools to divert connection requests to the connection pool 139, the application server 114 may allow an otherwise denied request if the request is from an exhausted connection pool that meets more stringent connection criteria, such as a significantly excessive actual wait time.

The application server 114 can limit the utilization of the spare database node 149 based on connection criteria that characterize the database nodes 141-148 that correspond to the connection pools 131-138. The performances of the database nodes 141-148 may be impacted by the database buffer cache and the global buffer cache, and may be measured by average page time. The database buffer cache is the portion of the system global area that holds copies of data blocks read from datafiles. All users concurrently connected to a database instance share access to the database buffer cache. The global buffer cache is the global logical cache that is comprised of all physical local buffer caches. The average page time is the amount of time (such as in seconds) it takes that page to load, from the initiation of the pageview, such as a click on a page link, to load completion in the browser.”

The SQL code that accesses data in a data block in the database partition 151, which is mapped to database node 141, may be executed by using a connection to the spare database node 149. At a high-level, as long as the requested data block is in the buffer cache of the database node that the data block is mastered on, no disk is accessed. The database node 141 can send a copy of the data block over the interconnect network 150 to the buffer cache of the spare database node 149. While waiting to receive the data block, the active session for the spare database node 149 may participate in a global cache wait event. As the traffic on the interconnect network 150 becomes more congested, the number and impact of such global cache wait events may increase, and performance may decrease. Typically, however, such events may take only milliseconds. If no limit is imposed on the number of database nodes 141-148 that may concurrently divert user requests for their cached database partitions 151-182 to the spare database node 149, theoretically user requests for all 32 database partitions 151-182 may hit the spare database node 149 within a short interval.

If user requests for partitions cached by multiple database nodes hit the spare database node 149 within a short interval, the buffer cache hit ratio on the spare database node 149 may be reduced. However, since the buffer cache hit ratio in production may be +99%, the global cache hit ratio can still be high. In such a situation, although the buffer cache efficiency of the spare database node 149 may decrease, the resulting cost incurred to average page time may be the cost of fetching a cached data block over the interconnect network 150.

Since row lock contention may be observed for organization identifiers that are mapped to multiple database nodes, similar contention may be observed when an organization identifier's traffic is split across its base or default database node and the spare database node 149. To minimize the impact on average page time, the application server 114 can require that at any given time only a limited number of the database nodes 141-148 may have elastic connection pools that can concurrently divert their user requests to the spare database node 149 via the connection pool 139.

The application server 114 can periodically query the Inter-Application Server Decision Table 1 depicted below, which is stored in content as a service, and determine which database node has an elastic connection pool until the next time period. For example, the decision table 1 indicates that the connection pool 132 for the database node 142 is elastic during the time period 1, the connection pool 131 for the database node 141 is elastic during the time period 2, and the connection pool 131 for the database node 141 is elastic during the time period 3, In this example, the selection of a connection pool that can divert connection requests to the connection pool 139 for the spare database node 149 is limited to the connection pool that is scheduled or planned to be selected by the decision table that includes its database node. Although decision table 1 depicts only 1 database node scheduled for an elastic connection pool during any time period, more than 1 database node may be scheduled for an elastic connection pool during any time period.

| Decision Table 1 | TTL Period 1 | TTL Period 2 | TTL Period 3 |
|---|---|---|---|
| Database Node 141 | 0 | 1 | 1 |
| Database Node 142 | 1 | 0 | 0 |
| Database Node 143 | 0 | 0 | 0 |
| Database Node 144 | 0 | 0 | 0 |
| Database Node 145 | 0 | 0 | 0 |
| Database Node 146 | 0 | 0 | 0 |
| Database Node 147 | 0 | 0 | 0 |
| Database Node 148 | 0 | 0 | 0 |

The application servers 114-118 can execute code similar to the example Java code below to identify which database node will have an elastic connection pool:

```
interface InterAppServerSpareNodeUserCacheV1 {
  Integer getOwner( );
  boolean acquireLock(Integer nodeId);
}
```

For a connection pool to be elastic, the connection pool must own the “elastic-node” lock in the content as a service. If a connection pool is able to acquire the lock, for the time-to-live of the lock, the database node corresponding to that connection pool has an elastic connection pool, which means that all connection pools across all application servers 114-118 for that database node may be elastic. If a connection pool is not able to acquire the lock, that connection pool is not elastic for the time-to-live of the lock. Only a connection pool that is under pressure attempts to acquire the lock, and there is a distinct lock for each of the application servers 114-118.

Alternatively, each of the application servers 114-118 can periodically query the Inter-App Server Decision Table 2 depicted below, which is stored in content as a service, and determine that the top N database nodes may have elastic connection pools until the next evaluation period. For example, the decision table 2 indicates that the connection pool 132 for the database node 142 and the connection pool 133 for the database node 143 are elastic during the evaluation period 1 because the database nodes 142 and 143 each had 10 new user requests in their wait lists, which resulted in the database nodes 142 and 143 getting elastic connection pools as the 2 busiest database nodes during the evaluation period 1. The decision table 2 indicates that the connection pool 131 for the database node 141 is not elastic during the evaluation period 1 because the database node 141 had only 1 new user requests in its wait list, which was therefore not 1 of the 2 busiest database nodes during the evaluation period 1.

In another example, the decision table 2 indicates that the connection pool 132 for the database node 142 and the connection pool 134 for the database node 144 are elastic during the evaluation period 2 because the database nodes 142 and 144 each had 10 new user requests in their wait lists, which resulted in the database nodes 142 and 144 getting elastic connection pools as the 2 busiest database nodes during the evaluation period 2. The decision table 2 indicates that the connection pool 133 for the database node 143 is not elastic during the evaluation period 2 because the database node 143 had only 1 new user request in its wait list, which was therefore not 1 of the 2 busiest database nodes during the evaluation period 2.

In yet another example, the decision table 2 indicates that the connection pool 132 for the database node 142 and the connection pool 134 for the database node 144 are elastic during the evaluation period N because the database nodes 142 and 144 each had 10 new user requests in their wait lists, which resulted in the database nodes 142 and 144 getting elastic connection pools as the 2 busiest database nodes during the evaluation period N. The application server 114 can use the total number of user requests in the wait lists or the estimated wait time to evaluate which database nodes have a history of being busy, which may suggest alternative actions, such as establishing a temporary mapping of an organization identifier to multiple database nodes, with the mapping expiring after its traffic subsides. In this example, the selection of a connection pool that can divert connection requests to the connection pool 139 for the spare database node 149 is limited to each connection pool that corresponds to a database node that is selected based on a wait list length, such as the two longest wait lists, or an estimated wait time. Although decision table 2 depicts 2 database nodes with the 2 longest wait lists for having an elastic connection pool during any evaluation period, any number of database nodes with the longest wait lists or the longest estimated wait times may be selected for having an elastic connection pool during any evaluation period, A wait list length can be a number of entities that are pausing for the availability of a resource. An estimated wait time can be an approximate calculation of how long an entity may be pausing for the availability of a resource.

| | Evaluation | Evaluation | Evaluation |
|---|---|---|---|
| | Period 1 | Period 2 | Period N |
| Decision Table 2 | (Total/Delta) | (Total/Delta) | (Total/Delta) |
| Database Node 141 | 1 | 1/0 | 1/o |
| Database Node 142 | 10 | 20/10 | 50/10 |
| Database Node 143 | 10 | 11/1 | 11/0 |
| Database Node 144 | 0 | 10/10 | 60/10 |
| Database Node 145 | 0 | 0 | 0 |
| Database Node 146 | 0 | 0 | 0 |
| Database Node 147 | 0 | 0 | 0 |
| Database Node 148 | 0 | 0 | 0 |

The application servers 114-118 can execute code similar to the example Java code below to identify which database nodes will have elastic connection pools:

```
interface InterAppServerSpareNodeUserCacheV2 {
  void incrementForNode(int node);
  List<Integer> getTopNNodes(int n);
}
```

If any connection pool has any available connections, the application servers 114-118 can select the connection pool. If none of an application server's connection pools have any available connections, then the application servers 114-118 can use connection criteria to select the connection pool associated with a wait list length, an estimated wait time, and/or a status as a spare database node. The Oracle distributed database management system 108 can calculate the estimated wait time based on the rolling average wait time multiplied by the wait list size. For example, since the connection pools 131-139 do not have any available connections for the database node 141, the application server 114 uses connection criteria to select the application server's connection pool 142 with the shortest wait list and the shortest estimated wait time.

If multiple connection pools have the shortest wait list and/or the shortest estimated wait time, and one of these connection pools is the connection pool 139 for the spare database node 149, then the application server 114 may select the connection pool 139 for the spare database node 149. A status can be a position or role.

Regardless of which connection criteria are used to select one of an application server's other connection pools, the application server provides the user request with an available connection, from the other connection pool, to another database node in the cluster, which enables the user request to access the requested data in the database partition cached by the database node for which no connections are available. For example, the application server 114 uses an available connection from the connection pool 139 to route Chris' request to the spare database node 149, which uses the Oracle RAC's Interconnect network 150 to request the data block that stores the October computer sales data. The database node 141, which caches the database partition 151 that includes the data block for the referenced data, responds to the Interconnect request by sending the data block via the Interconnect network 150 to the spare database node 149. Then the spare database node 149 enables Chris to use the laptop computer 104 to retrieve the October computer sales data that is stored in the partition 151 of the Oracle CRM database, even though the application server 114's connection pool 131 has no available connections to the database node 141 that caches the partition 151 which stores the October computer sales data.

The Oracle distributed database management system 108 can implement the MultiNodePartitionToNodeMappingRouter based on Partition-to-Node Mapping combined with Multi-Node Logic (DBContext), and implement MultiNodeSpareNodeAwareConnectionPoolRouter based on Partition-to-Node Mapping combined with both Multi-Node Logic and Spare Node (DBContext). The Oracle distributed database management system 108 can also implement PartitionToNodeMappingRouter based on Partition-to-Node Mapping (Connections) and implement SpareNodeAwareConnectionPoolRouter based on Partition-to-Node Mapping combined with Spare Node Flow (Connections).

The Oracle distributed database management system 108 can execute code similar to the example Java code below to implement an API for a MultiNodeAwarePartitionToNodeMappingRouter:

```
class MultiNodeAwarePartitionToNodeMappingRouter implements ConnectionPoolRouter {
...
  @Override
  DatabaseConnectionPool getConnectionPool(ConnectionKey connKey) {
  ConnectionPools connPools = connPoolsProvider.get( );
  String orgId = connKey.getOrgId( );
  return poolSpecifierProvider
    .getPoolSpecifierProvider(
      connPools,
        orgId,
      connKey.getUserId( ),
      connPools.getPartition(orgId),
        randomOffsetEnabled
        ? OffsetSpecifier.newDefaultOffsetSpecifier( )
          : OffsetSpecifier.newKnownOffsetSpecifier( ));
  }
}
```

The Oracle distributed database management system 108 can execute code similar to the example Java code below as an API for SpareNodeMultiNodeAwareRouter.

```
class SpareNodeMultiNodeAwareRouter implements ConnectionPoolRouter {
...
  DatabaseConnectionPool getDatabaseConnectionPool(ConnectionKey connKey) {
    DatabaseConnectionPool connPool =
    multiNodePartitionToNodeMappingRouter.getConnectionPool(connKey);
  Set<Integer> spareNodeIds = spareNodeProvider.get( );
  if (!spareNodeIds.isEmpty( )) {
    Set<DatabaseConnectionPool> connPools = new HashSet<>( );
    connPools.add(poolSpecifier.getReturnedPool( ));
    connPools.addAll(spareConnPools);
    connPool =
connPoolChooserProvider.get( ).chooseConnectionPool(connPools);
    return connPool;
  }
  return connPool;
  }
}
```

The application servers 114-118 can execute code similar to the example Java code below to generate a candidate connection pool list and choose a connection pool:

```
interface ConnectionPoolRouter {
  @Nonnull
  DatabaseConnectionPool getConnectionPool(ConnectionKey connKey);
}
interface ConnectionPoolChooser {
  @Nonnull
  DatabaseConnectionPool getConnectionPool(Set<DatabaseConnectionPool>connPools);
}
```

The Oracle distributed database management system 108 can execute code similar to the example Java code below as an API for ConnectionAcquirer using ConnectionPoolRouter:

```
class ConnectionAcquirer {
...
  ProtectedConnection acquireConnection(
    DbSpecifier dbSpecifier,
    GetConnParams getparams,
    boolean isAdditionalConnection,
    boolean isRoutable) {
    String orgId = dbSpecifier.getPartitionSpecifier( ).getOrganizationId( );
    DatabaseConnectionPool connPool = null;
    // Check if a ROCSContext is established...
      if (connPool != null) {
      if (orgId == null || !isRoutable) {
        connPool =
multiNodePartitionToNodeMappingRouter.getConnectionPool(con
    } else {
      String userId = null;
    if (connChooserCtxProvider.established( )) {
      userId = connChooserCtxProvider.get( ).getUserId( );
    }
    ConnectionKey connKey = ConnectionKeys.makeKey(orgId, userId);
    connPool = connPoolRouterProvider.get( ).getConnectionPool(connKey);
    }
  }
  return connPool;
  }
}
```

Each of the application servers 114-118 can divert connection requests between its connection pools 131-139 to reduce the number of ConnectionPoolTimeOut and ConnectionPoolTooManyWaitersExceptions. To determine whether diverting connection requests accomplishes this goal, the Oracle distributed database management system 108 can trend ConnectionPoolTimeOut and ConnectionPoolTooManyWaitersExceptions before and after enabling diversion of connection requests between the application server's connection pools 131-139. A decrease in exceptions does not in and of itself necessarily demonstrate that diversions of connection requests is effective, primarily because traffic patterns can change. Therefore, the Oracle distributed database management system 108 can perform a before and after analysis on a database instance that has a predictable traffic pattern. The Oracle distributed database management system 108 can also monitor the count of diverting connection requests by database node or by ConnectionKey.

The Oracle distributed database management system 108 can monitor average page time, which may be captured in a “runTime” field of any log record that inherits from CommonLogRecord. For example, the Oracle distributed database management system 108 can compare runTime and fields related to Oracle statistics across the various log records before and after enabling diversion of connection requests between the application server's connection pools 131-139. To make this comparison, the Oracle distributed database management system 108 can distinguish between a user request that was not diverted and a user request that was diverted. The DBPARTITION_basic field in the BasicLogRecord schema may be used to record the current organization identifier's database partition. For all LogRecordTypes that use LogContext and inherit from the CommonLogRecord, the value of DBPARTITION_basic field is the organization identifier's base or default database partition. For all LogRecordTypes that use LogContext and inherit from the CommonLogRecord, the identifier of every database node used by the user request is appended to the log line. However, “racNode” is not a field in either CommonLogRecord or in BasicLogRecord. The Oracle distributed database management system 108 can add the racNode field at runtime as an “extra field” in LogContext. The first database node in the list is the database node that was last used by the user request.

The Oracle distributed database management system 108 can add additional fields, such as an Integer field p2nNode and a Boolean field nonP2NNodeUsed, to BasicLogRecord. The field p2nNode can identify the database node for the organization identifier according to the database partition-to-database node mapping. If the spare database node 149 is used, then the field nonP2NNodeUsed may be set to true, and if the spare database node 149 is not used, then the field nonP2NNodeUsed may be set to false. This field is deliberately not specific to the spare database node 149. An alternative load balancing algorithm might be used.

The Oracle distributed database management system 108 can dynamically add the p2nNode and nonP2NNodeUsed fields at runtime via LogData::addExtraLogParam. Splunk naturally indexes such fields of the form fieldName-field Value, although this implicitly relies on the toString implementation of the underlying map. If an organization identifier is an organization identifier that maps to multiple database nodes, then the DBPARTITION_basic field points to the base or default database partition.

The Oracle distributed database management system 108 can track diversions and generate alerts based on diversions per database node, diversions per application server, and/or diversions per organization identifier. Diversions per database node may indicate whether a database node is overloaded. Diversions per application server may indicate whether the networked load balancer 112 is malfunctioning and whether an aggressive user-to-host affinity is in effect. Diversions per organization identifier may indicate whether processing requests that have a specific organization identifier has resulted in an excessive number of diversions, whether there is an error in the SQL software for a specific organization identifier, and/or whether a specific organization identifier is outgrowing its allocated database node(s).

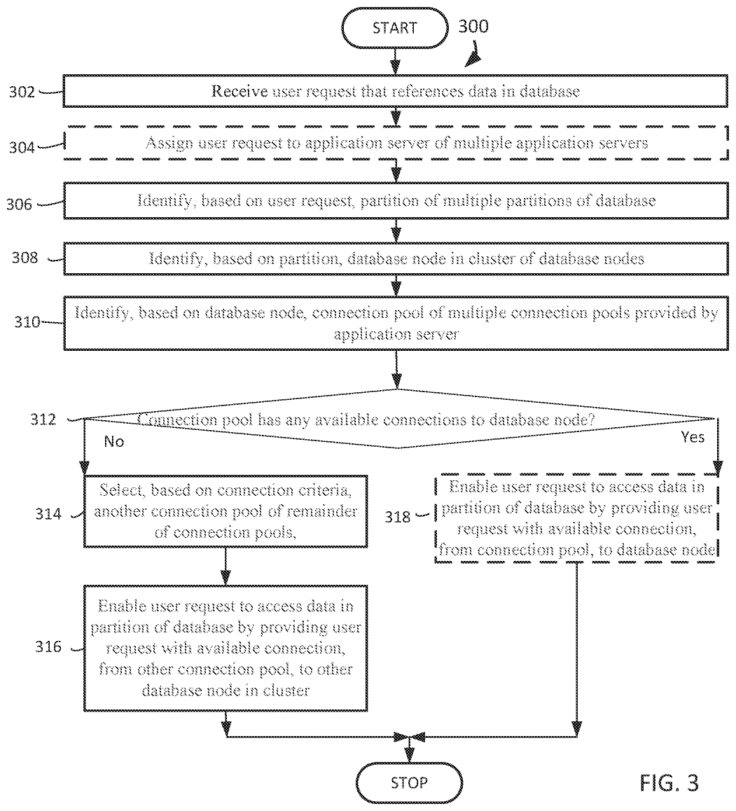

FIG. 3 is an operational flow diagram illustrating a high-level overview of a method 300 for elastic connection pools for database nodes. A user request that references data in a database is received, block 302. The system receives a user request that references data. For example, and without limitation, this can include the Oracle distributed database management system 108 receiving a request from the computer sales manager Chris' laptop computer 104 to retrieve October computer sales data in an Oracle CRM database.

After receiving a user request, the user request is optionally assigned to an application server of multiple application servers, block 304. The system uses a load balancer to assign a user request to an application server. By way of example and without limitation, this can include the Oracle distributed database management system 108 using the networked load balancer 112 to assign Chris' request to the application server 114 of the Oracle application servers 114-118.

Following the receipt of a user request, the user request is used to identify a partition of multiple partitions of a database, block 306. The system hashes a user request to the database partition for the data referenced in the user request. In embodiments, this can include the application server 118 using the hashing function 120 to hash Chris' request to the hash value 124 for the database partition 151, which stores the October computer sales data, in the Oracle CRM database.

Having identified the database partition for a user request, the database partition is used to identify a database node in a cluster of database nodes, block 308. The system maps the identified database partition to the database node that caches the database partition. For example, and without limitation, this can include the application server 114 using the mapping function 126 to map the hash value 124 for the database partition 151 to the map value 130 for the database node 141 in the Oracle cluster 140 of the database nodes 141-149

After identifying a database node, the database node is used to identify a connection pool of multiple connection pools provided by an application server, block 310. The system identifies the connection pool that provides connections for the identified database node. By way of example and without limitation, this can include, the application server 114 identifying the connection pool 131 that provides connections to route requests to the database node 141, because the Oracle cluster 140 has the 9 database nodes 141-149 and the application server 114 has the 9 corresponding connection pools 131-139.

Following the identification of a connection pool, a determination is made whether the connection pool has any available connections to the identified database node, box 312. The system determines whether the “correct” connection pool has any available connections for the database node that caches the database partition to which the user request is hashed. In embodiments, this can include the application server 114 determining whether the connection pool 131 has any available connections for the database node 141 that caches the database partition 151 which stores the requested October computer sales data. If the corresponding connection pool does not have any available connections to the identified database node, the method 300 continues to box 314 to select another connection pool from the same application server. If the corresponding connection pool has any available connections to the identified database node, the method 300 proceeds to box 318 to assign a connection from the corresponding connection pool to the user request.

If the corresponding connection pool does not have any available connections to the identified database node, connection criteria are used to select another connection pool from the remainder of the connection pools, box 314. The system uses connection criteria to select another connection pool from the same application server. For example, and without limitation, this can include the application server 114 using connection criteria to select the application server's connection pool 139 for the Oracle RAC's spare database node 149, because the corresponding connection pool 131 does not have any available connections for the identified database node 141. This specific selection is based on the connection pool 139 having more available connections than any of the application server 114's other connection pools 131-138 and because the spare database node 149 has a lower CPU utilization than any of the Oracle RAC 140's other database nodes 141-148.

Having selected another connection pool, a user request is enabled to access the referenced data in the database partition by providing the user request with an available connection, from the other connection pool, to another database node in the cluster, block 316. The system enables the user request to access the referenced data via a connection from an “incorrect” connection pool to an “incorrect” database node. By way of example and without limitation, this can include the application server 114 using an available connection from the connection pool 139 to route Chris' request to the spare database node 149, which uses the Oracle RAC's Interconnect network 150 to request the data block that stores the October computer sales data. The database node 141, which caches the database partition 151 that includes the requested data block, responds to the Interconnect request by sending the requested data block via the Interconnect network 150 to the spare database node 149. Then the spare database node 149 enables Chris to use the laptop computer 104 to retrieve the October computer sales data that is stored in the partition 151 of the Oracle CRM database, even though the application server 114's connection pool 131 has no available connections to the database node 141 that caches the partition 151 which stores the October computer sales data. Alternatively, if the user request that references data is a request to store updated October computer sales data, then the spare database node 149 enables Chris to use the laptop computer 104 to store the updated October computer sales data with the other October computer sales data that is stored in the requested data block. Next, the spare database node 149 responds to the updating of the data block by sending the updated data block via the Interconnect network 150 to the database node 141, which caches the database partition 151 that includes the updated data block. Then the method 300 terminates, which enables the processing of subsequent user requests.

If a corresponding connection pool has any available connections to the identified database node, the user request is optionally enabled to access the data in the partition of the database by providing the user request with an available connection, block 318. The system enables the user request to access the referenced data via a connection from the “correct” connection pool to the “correct” database node. By way of example and without limitation, this can include the application server 114 using an available connection from the connection pool 131 to connect Chris' request to the database node 141, because the application server 114's connection pool 131 has available connections to the database node 141 that caches the database partition 151 which includes the data block that stores the October computer sales data. The database node 141 responds to Chris' request by sending the data block that stores the referenced data to Chris' laptop computer 104 to retrieve the October computer sales data that is stored in the partition 151 of the Oracle CRM database. Then the method 300 terminates, which enables the processing of subsequent user requests.

The method 300 may be repeated as desired. Although this disclosure describes the blocks 302-318 executing in a particular order, the blocks 302-318 may be executed in a different order. In other implementations, each of the blocks 302-318 may also be executed in combination with other blocks and/or some blocks may be divided into a different set of blocks.

### System Overview

FIG. 4 illustrates a block diagram of an environment 410 wherein an on-demand database service might be used. The environment 410 may include user systems 412, a network 414, a system 416, a processor system 417, an application platform 418, a network interface 420, a tenant data storage 422, a system data storage 424, program code 426, and a process space 428. In other embodiments, the environment 410 may not have all of the components listed and/or may have other elements instead of, or in addition to, those listed above.

The environment 410 is an environment in which an on-demand database service exists. A user system 412 may be any machine or system that is used by a user to access a database user system. For example, any of the user systems 412 may be a handheld computing device, a mobile phone, a laptop computer, a workstation, and/or a network of computing devices. As illustrated in FIG. 4 (and in more detail in FIG. 5) the user systems 412 might interact via the network 414 with an on-demand database service, which is the system 416.

An on-demand database service, such as the system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 416” and the “system 416” will be used interchangeably herein. A database image may include one or more database objects. A relational database management system (RDMS) or the equivalent may execute storage and retrieval of information against the database object(s). The application platform 418 may be a framework that allows the applications of the system 416 to run, such as the hardware and/or software, e.g., the operating system. In an embodiment, the on-demand database service 416 may include the application platform 418 which enables creation, managing and executing one or more applications developed by the provider of the on-demand database service, users accessing the on-demand database service via user systems 412, or third party application developers accessing the on-demand database service via the user systems 412.

The users of the user systems 412 may differ in their respective capacities, and the capacity of a particular user system 412 might be entirely determined by permissions (permission levels) for the current user. For example, where a salesperson is using a particular user system 412 to interact with the system 416, that user system 412 has the capacities allotted to that salesperson. However, while an administrator is using that user system 412 to interact with the system 416, that user system 412 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 414 is any network or combination of networks of devices that communicate with one another. For example, the network 414 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 412 might communicate with the system 416 using TCP/IP and, at a higher network level, use other common Internet protocols to communicate, such as HTTP, FTP, AFS, WAP, etc. In an example where HTTP is used, the user systems 412 might include an HTTP client commonly referred to as a “browser” for sending and receiving HTTP messages to and from an HTTP server at the system 416. Such an HTTP server might be implemented as the sole network interface between the system 416 and the network 414, but other techniques might be used as well or instead. In some implementations, the interface between the system 416 and the network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 416, shown in FIG. 4, implements a web-based customer relationship management (CRM) system. For example, in one embodiment, the system 416 includes application servers configured to implement and execute CRM software applications as well as provide related data, code, forms, webpages and other information to and from the user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 416 implements applications other than, or in addition to, a CRM application. For example, the system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of the system 416 is shown in FIG. 4, including the network interface 420, the application platform 418, the tenant data storage 422 for tenant data 423, the system data storage 424 for system data 425 accessible to the system 416 and possibly multiple tenants, the program code 426 for implementing various functions of the system 416, and the process space 428 for executing MTS system processes and tenant-specific processes, such as running applications as part of an application hosting service. Additional processes that may execute on the system 416 include database indexing processes.

Several elements in the system shown in FIG. 4 include conventional, well-known elements that are explained only briefly here. For example, each of the user systems 412 could include a desktop personal computer, workstation, laptop, PDA, cell phone, or any wireless access protocol (WAP) enabled device or any other computing device capable of interfacing directly or indirectly to the Internet or other network connection. Each of the user systems 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 412 to access, process and view information, pages and applications available to it from the system 416 over the network 414. Each of the user systems 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 416 or other systems or servers. For example, the user interface device may be used to access data and applications hosted by the system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each of the user systems 412 and all of its components are operator configurable using applications, such as a browser, including computer code run using a central processing unit such as an Intel Pentium® processor or the like. Similarly, the system 416 (and additional instances of an MTS, where more than one is present) and all of their components might be operator configurable using application(s) including computer code to run using a central processing unit such as the processor system 417, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein. Computer code for operating and configuring the system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 416 is configured to provide webpages, forms, applications, data and media content to the user (client) systems 412 to support the access by the user systems 412 as tenants of the system 416. As such, the system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 5 also illustrates the environment 410. However, in FIG. 5 elements of the system 416 and various interconnections in an embodiment are further illustrated. FIG. 5 shows that the each of the user systems 412 may include a processor system 412A, a memory system 412B, an input system 412C, and an output system 412D. FIG. 5 shows the network 414 and the system 416. FIG. 5 also shows that the system 416 may include the tenant data storage 422, the tenant data 423, the system data storage 424, the system data 425, a User Interface (UI) 530, an Application Program Interface (API) 532, a PL/SOQL 534, save routines 536, an application setup mechanism 538, applications servers 5001-500x, a system process space 502, tenant process spaces 504, a tenant management process space 510, a tenant storage area 512, a user storage 514, and application metadata 516. In other embodiments, the environment 410 may not have the same elements as those listed above and/or may have other elements instead of, or in addition to, those listed above.

The user systems 412, the network 414, the system 416, the tenant data storage 422, and the system data storage 424 were discussed above in FIG. 4. Regarding the user systems 412, the processor system 412A may be any combination of one or more processors. The memory system 412B may be any combination of one or more memory devices, short-term, and/or long-term memory. The input system 412C may be any combination of input devices, such as one or more keyboards, mice, trackballs, scanners, cameras, and/or interfaces to networks. The output system 412D may be any combination of output devices, such as one or more monitors, printers, and/or interfaces to networks. As shown by FIG. 5, the system 416 may include the network interface 420 (of FIG. 4) implemented as a set of HTTP application servers 500, the application platform 418, the tenant data storage 422, and the system data storage 424. Also shown is the system process space 502, including individual tenant process spaces 504 and the tenant management process space 510. Each application server 500 may be configured to access tenant data storage 422 and the tenant data 423 therein, and the system data storage 424 and the system data 425 therein to serve requests of the user systems 412. The tenant data 423 might be divided into individual tenant storage areas 512, which may be either a physical arrangement and/or a logical arrangement of data. Within each tenant storage area 512, the user storage 514 and the application metadata 516 might be similarly allocated for each user. For example, a copy of a user's most recently used (MRU) items might be stored to the user storage 514. Similarly, a copy of MRU items for an entire organization that is a tenant might be stored to the tenant storage area 512. The UI 530 provides a user interface, and the API 532 provides an application programmer interface to the system 416 resident processes to users and/or developers at the user systems 412. The tenant data and the system data may be stored in various databases, such as one or more Oracle™ databases.

The application platform 418 includes the application setup mechanism 538 that supports application developers' creation and management of applications, which may be saved as metadata into the tenant data storage 422 by the save routines 536 for execution by subscribers as one or more tenant process spaces 504 managed by the tenant management process 510 for example. Invocations to such applications may be coded using the PL/SOQL 534 that provides a programming language style interface extension to the API 532. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 516 for the subscriber making the invocation and executing the metadata as an application in a virtual machine.

Each application server 500 may be communicably coupled to database systems, e.g., having access to the system data 425 and the tenant data 423, via a different network connection. For example, one application server 5001 might be coupled via the network 414 (e.g., the Internet), another application server 500x-1 might be coupled via a direct network link, and another application server 500x might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also may be used. For example, in certain embodiments, three consecutive requests from the same user could hit three different application servers 500, and three requests from different users could hit the same application server 500. In this manner, the system 416 is multi-tenant, wherein the system 416 handles storage of, and access to, different objects, data and applications across disparate users and organizations.

As an example of storage, one tenant might be a company that employs a sales force where each salesperson uses the system 416 to manage their sales process. Thus, a user might maintain contact data, leads data, customer follow-up data, performance data, goals and progress data, etc., all applicable to that user's personal sales process (e.g., in the tenant data storage 422). In an example of a MTS arrangement, since all of the data and the applications to access, view, modify, report, transmit, calculate, etc., may be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 416 might also maintain system level data usable by multiple tenants or other data. Such system level data might include industry reports, news, postings, and the like that are sharable among tenants.

In certain embodiments, the user systems 412 (which may be client systems) communicate with the application servers 500 to request and update system-level and tenant-level data from the system 416 that may require sending one or more queries to the tenant data storage 422 and/or the system data storage 424. The system 416 (e.g., an application server 500 in the system 416) automatically generates one or more SQL statements (e.g., one or more SQL queries) that are designed to access the desired information. The system data storage 424 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1-20. (canceled)

21. A system, comprising:
one or more processors; and
a non-transitory computer readable medium storing a plurality of instructions, which when executed, by the one or more processors cause the system to:
receive, at an application server that serves an application to a plurality of client devices, a user request that references data in a particular one of a plurality of partitions of a database;
maintain, by the application server, a plurality of connection pools, each associated with a respective one of a plurality of database nodes that cache the plurality of partitions;
identify, based on the user request, the respective connection pool of a database node that caches the particular partition;
in response to a determination that the connection pool does not have any available connections from the application server to the database node, select another one of the plurality of connection pools having an available connection to another database node; and
communicate, by the application server, via the available connection with the other database node to service the user request, wherein the other database node is configured to obtain the data from the database node that caches the particular partition.
